(19) United States
(12) Patent Application Publication
(10) Pub. No.: US 2006/0116289 A1
(43) Pub. Date: Jun. 1, 2006

(54) Biologic-chemical herbicide compositions and methods of use

(75) Inventors: Thomas A. Selvig, Jacksonville, FL (US); Paul C. Porter, Jacksonville, FL (US)

Correspondence Address: MCKENNA LONG & ALDRIDGE LLP, 1900 K STREET, NW, WASHINGTON, DC, 20006, US

(73) Assignee: Naturize Biosciences Inc., Jacksonville, FL (US)

(21) Appl. No.: 11/320,801

(22) Filed: Dec. 30, 2005

Related U.S. Application Data
(63) Continuation of application No. 10/141,828, filed on May 10, 2002, now abandoned.
(60) Provisional application No. 60/363,349, filed on Mar. 12, 2002.
(60) Provisional application No. 60/290,039, filed on May 11, 2001.

(51) Int. Cl. A01N 63/00

(52) U.S. Cl. 504/117

(57) ABSTRACT

The present invention is directed to biologic-chemical herbicide compositions (BCHs) for controlling or preventing weeds that include one or more chemical herbicides and microorganisms including gram-positive and/or gram-negative bacteria and yeast. The addition of a biologic microbial component to one or more chemical herbicides significantly increases the efficacy of the chemical herbicide thereby permitting lower amounts to be used to achieve a desired level of weed control. Any chemical herbicide or combination of herbicides can be used, including fatty acid herbicides like Round-UP®. The BCHs typically also include an optional nutrient component in an amount sufficient to support the growth and replication of the microorganisms. If the BCH is applied to soil rich in nutrients, or if the crops would support the growth of the microorganisms in the BCHs, then the nutrients can be omitted.

This application claims the benefit of Provisional Application No. 60/290,039, filed on May 11, 2001, and to Provisional Application No. 60/363,349 filed on Mar. 12, 2002, the entire contents of which are hereby incorporated by reference as if fully set forth herein, under 35 U.S.C. Section 120.

### BACKGROUND OF THE INVENTION

### Field of the Invention

The present invention relates to herbicide compositions and their use for controlling or preventing infestations of weeds.

The present invention relates to environmentally compatible herbicidal compositions. Salts of fatty acids, primarily, sodium or potassium fatty acid salts, have been used as herbicides, under the trademark Round-UP® (Monsanto Corporation). Featonby-Smith and Van Staden (1982), Dropkin (1969), Sawnhmey (1975). While these fatty acids and chemical herbicides have excellent herbicidal qualities with no known long-term environmental effects, the known herbicides including as Round-UP®, are limited by temperature restrictions, cost constraints due to high application rates, slow results and incomplete desiccation and mortality of target plants.). Other effective non-fatty acid chemical herbicides are also known, however, many of these have long-term adverse environmental consequences. There is therefore a great need for decreasing the amount of herbicide used to control weeds.

The present invention of herbicidal compositions described below overcomes these deficiencies by improving the speed of reaction, the percentage and rate of target plant mortality, and increasing the range of temperature-dictated application timing while also reducing the amount and frequency of application.

### DEFINITIONS

“Agronomically acceptable salts” as used herein means mineral salts that do not induce negative effects on agricultural crops when used properly. They include, metal salts such as sodium, potassium, calcium and magnesium salts, ammonium salts such as isopropyl ammonium salts and trialkylsulfonium salts such as triethylsulfonium salts.

“cfu” as used herein means colony forming unit.

“Complex humate-based carbon nutrient-containing matrix” as used herein means any matrix that contains complex humate-based carbon nutrients. Such nutrients include but are not limited to sugars (including glucose, fructose, and molasses), plasma, manure tea, peat extracts, compost extracts, coal extracts, lenordite extracts, kelp or extracts thereof, and other humic matrices known in the art that contain humic molecules that are rich in macronutrients, nitrogen, phosphorus and/or potassium. The matrix may also contain growth-stimulating compounds such as a blend of botanic/carbohydrates, growth factors, amino acids and micro-nutrients including calcium, boron, copper, molybdemum, manganese, magnesium, iron, sulfur and zinc as needed. The extracts from manure, peat, compost and leanoride contain fulmic and ulimic acids.

“Fungus” as used herein is a general term used to denote a group of eukaryotic protists, including mushrooms, yeasts, rusts, molds, smuts, etc., which are characterized by the absence of chlorophyll and by the presence of a rigid cell wall composed of chitin, mannans and sometimes cellulose. Fungi are usually of simple morphological form or show some reversible cellular specialization, such as the formation of pseudoparenchymatous tissue in the fruiting body of a mushroom. The dimorphic fungi grow, according to environmental conditions, as molds or yeasts.

“Herbicide” as used herein is any pesticide used to destroy or inhibit plant growth; a weed killer, including any compound that kills grassy broadleaf, annual or perennial plants.

“Humic molecule” as used herein means a carbon molecule with open and available hydrogen and oxygen bonding sites and exchange capacity.

“Nutrient matrix” as used herein means a matrix that provides growth-stimulating compounds for supporting microbial growth and multiplication, and that is rich in nitrogen, phosphorous and/or potassium macronutrients. The nutrient matrix may optionally contain vitamins and beneficial enzymes.

“Label Rate” as used herein means the amount of active ingredient of a chemical herbicide applied as recommended by the manufacturer.

“Pesticide” is any substance or mixture of substances intended for preventing, destroying, repelling, or mitigating any pest. Pests can be insects, mice and other animals, unwanted plants (weeds), fungi, or microorganisms like bacteria and viruses. Though often misunderstood to refer only to insecticides, the term pesticide also applies to herbicides, fungicides, and various other substances used to control pests. Under United States law, a pesticide is also any substance or mixture of substances intended for use as a plant regulator, defoliant, or desiccant.

“Plant” as used herein includes seedlings, bushes and trees.

“Phytohormones” as used herein means plant hormones including any of the hormones produced naturally in plants and that are active in minute amounts in controlling growth and other functions at a site remote from the place of production. The three principal types are auxins, cytokinins and gibberellins.

“Suppressive Bacteria” as used herein means any bacteria that can kill or inhibit the growth of fungi by any means.

“Weeds” as used herein includes any undesirable plant that can be eliminated or controlled with a herbicide.

### SUMMARY OF THE INVENTION

One aspect of the invention is directed to herbicide compositions that include (a) one or more chemical herbicides, and (b) microorganisms in a biologic component, that includes gram-positive and/or gram-negative bacteria, yeast and even certain beneficial fungi that are not inhibited or killed by the chemical herbicide. These compositions are called biologic-chemical herbicides, hereinafter “BCHs.” The BCH compositions typically contain optional (c) nutrients in an amount sufficient to support the growth and replication of the microorganisms in the biologic component. One instance in which the nutrient component can be eliminated is where the herbicide composition is applied to organic soil that is rich in nutrients. Any nutrients that support the growth and replication of the microorganisms can be used. In one aspect, the nutrient component is a complex carbon nutrient-containing matrix rich in nitrogen, phosphorous and potassium macronutrients. The compositions optionally include an agriculturally effective amount of adhesive, surfactant or dispersant. Any chemical herbicide or combination of herbicides can be used in the compositions of the present invention. Examples of chemical herbicides include fatty acid herbicides such as Round UP™ sold by Monsanto Corporation, and other non-fatty acid herbicides including those listed in Table 2 below. The microorganisms can be in either the vegetative or spore form, or both.

In another aspect, the invention is directed to methods of controlling or preventing weeds by applying the BCH compositions. In another aspect, the amount applied per a unit area of a chemical herbicide in the BCH is within a range of from about a maximum label rate or amount per the unit area recommended by a manufacturer of the chemical herbicide, to about 10% of a minimum label rate or amount per the unit area recommended by the manufacturer. In another aspect, the amount of microorganisms in the BCH compositions is from about 1×10⁴ to about 1×10¹⁴ cfu/acre or per treated acre.

### DETAILED DESCRIPTION

The present invention relates to environmentally compatible herbicide compositions that include one or more chemical herbicides, plus a biologic component that includes microorganisms such as bacteria, yeast and fungi. An aspect of the invention includes methods of using the new biologic-chemical herbicide compositions to control, prevent or reduce weed infestations. The new BCH compositions can be sprayed, used as soil drenches, or applied in dry form as powders as is described below.

It has been discovered that adding a biologic component such as bacteria, yeast, fungi or mixtures thereof to one ore more chemical herbicide(s), significantly reduces the amount of chemical herbicide(s) required to prevent or control weeds. The new herbicide compositions of the present invention are hereinafter referred to as biologic-chemical herbicide compositions (“BCHs”). BCHs permit the use of less chemical herbicide in each application. BCHs therefore have proportionately lowered environmental and plant toxicity than the same chemical herbicides applied alone in amounts and with the frequencies currently recommended by manufacturers. The new BCHs can be readily produced for commercial use, are cheaper because lower amounts of chemical herbicides are required, and find utility in treating a wide range of weeds by varying the chemical component of the composition. BCHs can be used to treat plants, cuttings, and plant media.

The biologic-chemical herbicide compositions of the present invention contain:
a. a biologic component containing microorganisms including bacteria, yeast, fungi, microfungi, mold, lichens, algae, viruses, protozoa, or mixtures thereof; and
b. one or more chemical herbicides, that can be organic, inorganic, systemic or contact herbicides. The herbicides include fatty acid herbicides such as Round-UP®, and the herbicides listed in Table 2 below.

The BCH compositions typically further contain:
c. an optional nutrient component that provides growth stimulating compounds, including vitamins and enzymes, for supporting the growth and replication of the microorganisms in the biologic component.

The present invention may optionally contain one or more broad-base adhesives, surfactants or dispersants as is common in the art, to enhance herbicide adsorption onto the plants, seeds, and fruits. Other additives known in the art may also be optionally included such as pesticides, insecticides, miticides, herbicides, acaracides, gibberellins, nematocides, and molluskicides. The only caveat is that any additive(s) should be compatible with the main components of the herbicide composition, for example, the additives should not be substantially toxic to the microorganisms, and they should not degrade or inactivate the chemical herbicide(s).

Other embodiments are further directed to methods of preventing, treating or reducing the presence of weeds by spraying or inoculating plants or soil with the BCHs of the present invention.

The BCH of the present invention have little or no residual soil activity, are rapidly degraded, and soil microorganisms can use the nutrients in the herbicides. BCHs are also substantially non-toxic to humans and animals, and are not corrosive to eyes and skin. BCHs can be applied as other herbicides known in the art are applied, including as a spray, soil drench, or powder. BCHs can also be used as dressing agents for plant media and plant cuttings.

The BCH compositions are effective against weeds including soybean, morning glory, hemp sesbania, downy brome, panicum, sugar beets, wild buckwheat, lambs quarters, wild poinsettia, wheat, cockle bur, smart weed, clover, nut sedge, pansies, grasses (including Johnson grass, barnyard grass and quack grass), thistle, velvet leap, pusley, rice and sorghum.

The Biologic Component

Microorganisms in the biologic component can be (1) inactive spores, (2) active, living and multiplying microorganisms in the vegetative state, or (3) a combination of spores and vegetative microorganisms. The biologic component should be compatible with the chemical herbicide, i.e., the microorganisms in the biologic component should not be inactivated or killed by the chemical herbicide or other additives.

Mixtures of bacteria inevitably contain some dead bacteria, however, these are not harmful to the targeted plants. Indeed the metabolic products of dead bacteria such as enzymes are useful to the targeted plants. Bacteria and other microorganisms are small enough to be sprayed even through blast systems, which use high pressure and small apertures with little loss of bacteria numbers or viability. Further, the agricultural industry has identified many non-pathogenic bacteria and other microorganisms that can be used in the present compositions. When applied as foliar sprays, the microorganisms, the chemical herbicides and the nutrients in the BCH compositions will cover the plant tissue, including the leaf surface, stems, fruit, and shoots. If applied as soil inocula, the microorganisms will spread to and cover the plant's roots.

In one aspect of the present invention, BCH compositions are specifically formulated to include microorganisms that are known to control or suppress one or more types of pathogenic fungi, although bacteria and other microorganisms without suppressive activity can also be used. Microorganisms that control soil-borne fungal pathogens include Trichoderma sp., Bacillus subtilis, and Penicillium sp; microorganisms that control insects include Bacillus sp. e.g. Bacillus popalliae. These microorganisms are well known and are readily available from public depositories including the American Tissue Culture Collection (ATCC). In another aspect, microorganisms are selected that have other qualities that are beneficial to the soil that could enrich the soil or that would benefit crops planted there after the weeds are controlled. Such bacteria include. Azospirillum (gram-positive bacteria) that are reported to increase seed yield and dry matter production of sesame when applied with humic acid.

Examples of bacteria for use in the present invention include but are not limited to: Bacillus (gram-positive bacteria) sp., especially Bacillus subtilis including A and B, Bacillus amyloiquefaciens A, B and C, and phosphorous stabilizing Bacillus organisms such as Bacillus azotofixans, Bacillus polymyxa, Bacillus licheniformis, Bacillus megatherium, Bacillus coagulans, and Bacillus pumulis; Clostridium (gram-positive bacteria), such as Clostridium pasteurianum; Rhodopseudomonas, such as Rhodopseudomonas capsula; Rhizobium that fix atmospheric nitrogen; cytokinin-producing microorganisms such as Azobacter (gram-negative bacteria) including Azobacter vinelandei and Azobacter chroococcum; microorganisms from the genera Pseudomonas, such as Pseudomonas fluorescens; Athrobacter (gram-negative bacteria), such as Anthrobacter globii; Penicillin (gram-positive bacteria); Flavobacterium (gram-positive bacteria) sp.; Saccharomyces (fungus), such as Saccharomyces cerevisiae; Streptomyces (fungus), including Streptomyces greisus; Actinomyces (fungus); and Trichoderma (soil fungi).

Two different mixtures of bacteria that can be used in the embodiments of the present invention are Naturize PRIME® and Naturize RAPID RESPONSES, described in Table 1.

TABLE 1

| Contents: | Concentration: |
|---|---|
| Naturize PRIME ® | |
| Bacillus subtilis A | 28 × 10⁵ cfu/ml |
| Bacillus amyloliquefaciens A | 7.5 × 10⁵ cfu/ml |
| Bacillus amyloliquefaciens B | 9.5 × 10⁵ cfu/ml |

All bacteria in Naturize PRIME ® are in spore form. Naturize PRIME ®
(Spore form) contains a total of 4.5 × 10⁶ cfu/ml.

| | |
|---|---|
| Naturize ™ TM RAPID RESPONSE ® | |
| Bacillus subtilis B | 2.2 × 10⁸ cfu/ml |
| Bacillus amyloliquefaciens C | 5.9 × 10⁷ cfu/ml |
| Bacillus subtilis | 8.9 × 10⁷ cfu/ml |

All bacteria in Naturize RAPID RESPONSE ® are active in the vegetative
form. Rapid (Vegetative form contains a total of 3.68 × 10⁸ cfu/ml.

The bacteria in Naturize RAPID RESPONSE™ and Naturize PRIME™ have some inherent, suppressive activity against pathogenic fungi.

The amount of microorganisms and chemical herbicide(s) in the final BCH formulation will vary significantly with the type of herbicide used, the species of weeds to be controlled, the crop being sprayed, environmental disease pressure, climate, and the like which can be determined based on routine experimentation. Typically, the amount of microorganisms included in the BCH compositions of the present invention will vary over a wide range, from about 1×104 to about 1×1014 cfu per acre or per treated acre.

The Nutrient Component

The nutrient component can be any nutrient matrix that supports the growth of the microorganisms in the biologic component, including matrices that are rich in nitrogen, phosphorous and potassium macronutrients, and vitamins and enzymes. Any combination of naturally occurring or synthetic nutrients can be used. In one aspect, the nutrient matrix is a complex humate-based carbon nutrient source as defined herein. Under certain conditions the nutrient component can be eliminated, for example, where the compositions are applied to organic soils that are rich in complex carbon compounds. Such BCH compositions without a nutrient component can be applied to organic soils as soil drenches. The nutrient component can also be eliminated where the crops and the weather conditions would support the growth of the microorganisms in the BCH compositions once they are applied.

One example of a nutrient component is a concentrated complex humate-based carbon nutrient-containing matrix called Naturize Plus®, which contains 2.3 volume % humic acid, and 5.1 volume % kelp extract (Ascophylum nodostum) dissolved in aqueous solution.

Biologic-Chemical Herbicides: Addition of Microorganisms to Round-Up Increased Efficacy

Example 1 is a description of different formulations of microbes and nutrients that can be used in the embodiments of the present invention. Examples 2 and 3 set forth the results of experiments that compared the efficacy in controlling certain weeds of full strength ready-to-use Round UP® alone, to half strength Round UP™ with and without microbes and nutrients. The results of a greenhouse trial on pansies in Example 2 show that seven days after treatment with full-strength undiluted Round-UP® sprayed to runoff, there was a decline in plant growth which was measured as a visible loss of turgor, color fade, height reduction and leaf drop. However there was no mortality. By contrast, mortality was achieved seven days after spraying pansies with either (1) half-strength ready-to-use Round-UP® with added Bacillus spores (supplied by Naturize™ Prime Microbes) and (supplied by Naturize™ Plus), or (2) half strength ready-to-use Round UP™ plus a combination of spore and vegetative microbes (supplied by Naturize™ Prime and Naturize™ Rapid Response) and nutrients (supplied by Naturize™ Plus). These formulations included harpin protein and surfactant, which are optional. Without being bound by theory, it is believed that harpin protein accelerates weed growth making the weeds more vulnerable to desiccation with the herbicide compositions.

The results of a field test of the efficacy of various concentrations of Round-UP®, with and without microbes and nutrients, are reported in Example 3. Twenty-seven 18-inch circles of wild clover, pusley, ragweed and thistle were divided into groups of three. The plants were then sprayed to runoff with approximately two liquid ounces of either full strength ready-to-use Round-UP®, or a BCH composition of half-strength ready-to-use Round-UP® plus Bacillus spores (supplied by Naturize™ Prime) and nutrients supplied by Naturize™ Plus. At 7 days the clover mortality was 100% with both mixes. However, full strength ready-to-use Round-UP® was only effective in desiccating clover. The other plants exhibited only partial desiccation, and they retained significant vigor to regenerate and survive. By contrast, the BCH formulations of the present invention with only half-strength Round-UP® ready-to-use plus microbes and nutrients, induced complete mortality all of the plants after seven days. Not only was the new BCH more effective than Round-UP® alone, it was more effective with only one half of the amount of chemical herbicide in the formulation. Importantly, the addition of microbes broadened the spectrum of weeds against which Round-UP® was effective.

In one aspect of the invention the amount of a chemical herbicide in the BCH ranges from about the maximum label rate, to about 10% of the minimum label rate. Where the BCH comprises more than one chemical herbicide, the amount of each chemical herbicide in the final composition can similarly range from about the maximum label rate, to about 10% of the minimum label rate of the chemical herbicide.

If the chemical herbicide(s) in the final BCH composition is at or near fifty percent of the minimum label rate or greater, then the BCH can be applied less frequently than the recommended frequency of application of the chemical herbicide alone. In summary, the addition of a biologic component to chemical herbicide(s) thus permits the application of substantially lower amounts of chemical herbicide over time either by applying less chemical herbicide per application, or by reducing the number of applications, or both.

The BCHs of the present invention will be diluted to different strengths depending on how they are applied. For example, if it is determined that the correct amount of BCH to be applied to a given crop is one pint per treated acre, this one pint of herbicide will be diluted: (1) to a volume of about 5 gallons if it is applied to the ground, (2) to a volume of between about 5 and 10 gallons if it is applied as aerials (by airplanes), (3) to a volume of about 35 gallons if it is applied by a ground rig, or (4) to a volume of between about 10,000 and 100,000 gallons if it is applied when using irrigation methods. Thus, the range of dilution varies by a factor of about 105. The biologic component and optional nutrient component will be similarly diluted based on the mode of application. The herbicides of the present invention are typically applied in a more dilute solution when used as a soil drench than they are when applied as a foliar spray. The present BCH compositions can be used on any plants including plant media, and seedlings.

The BCH and related methods of the present invention include the use of any known chemical herbicide or combinations thereof, as long as they are not used in amounts that are substantively toxic to the microorganisms in the composition or to the desirable crops being sprayed. Almost any microorganism (including bacteria, yeast, algae and fungi, or combinations thereof) can be used, and any nutrient source that would support the growth of the microorganisms in the biologic component can be used. Any chemical herbicide(s) can be used in the present invention

In certain embodiments of the present invention, the BCH compositions include fatty acid herbicides like ROUND UP™ (known as glyphosate and N-phosphonomethylglycine) either alone or in combination with other herbicides, plus a biologic component, with or without nutrients. Various salts of glyphosate can also be used in the present invention. Formulations of glyphosate and methods of use for killing and controlling weeds are disclosed in U.S. Pat. Nos. 3,799,758 and 4,405,531, all of which are incorporated herein by reference in their entirety. Other patents that describe salts of glyphosate and methods of preparation include U.S. Pat. Nos. 4,507,250; 4,397,676; 4,481,026; and 4,140,513, all of which are incorporated herein by reference in their entirety. Other fatty acid herbicides that can be used in the present invention include pelargonic acid, caprylic acid, undecanoic acid, carpric acid, glufosinate-ammonium, cinidon-ethyl (described in JP-62-185071A), and ammonium-DL-homoalanin-4-yl(methyl-phosphinate, and ethyl 2-chloro-3-[2-chloro-5-(1,3 dioxo-4,5,6,7-tetrahydroisoindolin-2-yl)phenylacrylate (described in U.S. Pat. No. 6,194,351, all of which are incorporated herein by reference in their entirety).

The fatty acid herbicides preferably have a hydrocarbon chain with between 8-12 carbon atoms, but any fatty acid herbicide can be used in the present BCH compositions.

Other chemical, non-fatty acid herbicides that can be used in the present invention are listed by class below. Combinations of any of these herbicides and salts thereof can also be used. Selecting more than one herbicide to include in a BCH composition may enable better control or higher killing rates of a given variety of weeds, or control of more types of weeds.

TABLE 2

| Herbicide Classes | Common Name | Brand Names |
|---|---|---|
| Chloroacetamides | Pronamide | Kerb |
| | Acetochlor | Harness |
| | Dimethenamid | Frontier |
| | Metolachlor | Dual |
| | | Dual Magnum |
| | Alachlor | Lasso |
| | | Micro-Tech |
| Amides | Propanil | Stam |
| | | Stampede |
| Oxyacetamides | Fluferacet | Axiom (one of the |
| | | active ingredients) |
| Sulfonamides | Flucarbazone | Everest |
| Ureas | Fluometuron | Cotoran |
| | | Mefuron |
| | Diuron | Karmex |
| | | Direx |
| | Linuron | Linex |
| | | Lorox |
| Dinitroauilines | Trifluralin | Treflan |
| | Ethalfluralin | Sonalan |
| | | Curbit |
| | Pendimethalin | Prowl |
| | | Pendimax |
| | Oryzalin | Surflan |
| | Benefin | Balan |
| Imidazolinones | Imazaquin | Scepter |
| | Imazethapyr | Pursuit |
| | Imazamox | Raptor |
| Diphenylethers | Acifluorfen | Blazer |
| | | UltraBlazer |
| | Fomesafen | Reflex |
| | | Flexstar |
| | Oxyfluorfen | Goal |
| | Lactofen | Cobra |
| Carbamates | Asulam | Asulox |
| Thiocarbamates | Triallate | Far-Go |
| | Butylate | Sutan |
| | EPTC | Eptam |
| | | Eradicane |
| Triazines | Atrazine | Aafrex |
| | Cyanazine | Bladex |
| | | Cy-Pro |
| | Prometryn | Caparol |
| | | Cotton-Pro |
| | Hexazinone | Velpar |
| | Simazine | Princep |
| | Ametryn | Evik |
| Phenoky-carboxylic Acids | 2,4-D | |
| | 2,4-DB | |
| | MCPA | |
| Sulfonylureas | Nicosulfuron | Accent |
| | Chlorimuron | Classic |
| | Metsulfuron | Ally |
| | Triasulfuron | Amber |
| | Prosulfuron | Peak |
| | Halosulfuron | Permit |
| | Thifensulfuron | Pinnacle |
| | | Harmony GT |
| | Chlorsulfuron | Glean |
| | Bensulfuron | Londax |
| | Sulfosulfuron | Maverick |
| | Sulfometuron | Oust |
| | Rimsulfuron | Matrix |
| | Primisulfuron | Beacon |
| | Tribenuron | Express |
| Aryloxyphenoxy propionates | Quizalofop | Assure |
| | Fenoxaprop | Silverado |
| | Diclofop | Hoelon |
| | Fluazifop | Fusilade DX |
| Triazolinones | Carfentrazone | Aim |
| | Sulfentrazone | Spartan |
| | | Authority |
| | | Gauntlet |
| Cyclohexanediones | Sefhoxydim | Poast |
| | | Poast Plus |
| | Clethodim | Select |
| | | Prism |
| Phthalamates | Naptalam | Alanap-L |
| N-phenylphthalimide | Flumiclorac | Resource |
| Glycines | Sulfosate | Touchdown |
| | Glyphosate | Roundup Ultra |
| | | Roundup Original |
| | | Roundup Ultra Max |
| | | Rattler |
| | | Glyphomax |
| | | Glyphomax Plus |
| Nitrile | Bromoxynil | Buctril |
| | Dichlobenil | Casoron |
| Triazinones | Metribuzin | Sencor |
| | | Lexone |
| Triazolopyrimidines | Disclosulam | Strongarm |
| | Flumetsulam | Python |
| | Cloransulam | First Rate |
| Phenylpyridazines | Norflurazon | Zorial |
| | | Evital |
| | Pyridate | Tough |
| Benzothiadiazinones | Bentazon | Basagran |
| Benzoic Acids | Dicamba | Banuel |
| | | Clarity |
| Isoxazoles | IsoxaFlutole | Balance |
| Bypridiliums | Paraquat | Boa |
| | | Gramoxone Max |
| | | Gramoxone Extra |
| | | Diquat |
| | | Cyclone Max |
| Quinolin | Carboxylic Acids | |
| | Quinclorac | Facet |
| Uracils | Bromacil | Hyvar |
| | Terbacil | Sinbar |
| Isoxazolidines | Clomazone | Command |
| Phosphinic Acids | Glufosinate | Liberty |
| | | Rely |
| Phosphorodithioates | Bensulide | Prefar |
| Pyradazinones | Pyrazon | Pyramin |
| Pyrimidinylthiobenzoates | Pyrithiobore | Staple |
| Pyridinecarboxylic Acids | Clopyralid | Stinger |

Formulations

The various components of the BCH compositions (the nutrients, the biologic component, humate, surfactants, dispersants, chemical herbicides etc.) are typically in a suspension or solution when formulated into the final composition, however, these components can be added in dry form. Final formulations can be determined using routine greenhouse testing.

The compositions of the present invention can be applied in any way known in the art. They can be applied formulated or unformulated, directly to the foliage of a plant, to seeds or to other medium in which plants are growing or are to be planted. The BCHs can be sprayed on, dusted on or applied as a cream or paste formulation, or they can be applied as a vapor or as slow release granules.

As a foliar spray, the herbicide compositions are applied to plant foliage by methods commonly employed, such as conventional high-gallonage hydraulic sprays, low-gallonage sprays, air-blast, aerial sprays and dusts. Application can be to any part of the plant including the foliage, stems, branches or roots, or to soil surrounding the roots. The herbicides of the invention may also be injected into plants or sprayed onto vegetation using electrodynamic spraying techniques or other low volume methods, or applied by land or aerial irrigation systems. The dilution and rate of application will be adjusted depending upon the type of equipment employed, the method and frequency of application desired, the crop, the climate, and the weeds to be controlled. The amount of herbicide, bacteria, nutrient matrix and additives can be adjusted to accommodate the growers' particular needs.

The microorganisms can be separately encapsulated in water soluble coatings, e.g., dyed or undyed gelatin spheres or capsules, or by micro-encapsulation to a free flowing powder using one or more of gelatin, polyvinyl alcohol, ethylcellulose, cellulose acetate phthalate, or styrene maleic anhydride. The compositions can also be formulated in paraffin. The separately encapsulated microorganisms can then be mixed with the non-encapsulated components. In one embodiment, encapsulation of the microorganisms includes nutrients as well as the microorganisms.

For the preparation of emulsifiable concentrates, the compositions used in the invention can be dissolved in suitable solvents or a mixture of solvents, together with an emulsifying agent that permits dispersion of the active compounds in water. Wettable powders suitable for spraying, can be prepared by admixing the composition with a finely divided solid, such as clays, inorganic silicates and carbonates, and silicas and incorporating wetting agents, sticking agents, and/or dispersing agents in such mixtures. Dusts are prepared by mixing the composition of the present invention, or salts and complexes thereof, with finely divided inert solids, which can be organic or inorganic in nature. Inert materials useful for this purpose include botanical flours, silicas, silicates, carbonates and clays.

Compositions according to the embodiments can also be prepared by formulating each of the active ingredients separately, and then mixing them together. The application amount varies with weather conditions, formulation, application timing, application method, application location, or the objective weeds to be controlled.

The present compositions may be formulated to include a solid carrier to make, for example solupak and tablets. When formulated into dustable powders or granules, fillers can be used such as kaolin, bentonite, kieselguhr, dolomite, calcium carbonate, talc, powdered magnesia, fuller's earth, gypsum, diatomaceous earth and china clay. Such granules can be preformed granules suitable for application to the soil without further treatment. These granules can be made either by impregnating pellets of filler with the active ingredient or by pelleting a mixture of the active ingredient and powdered filler.

When the microorganisms are in spore form, they can be formulated into soluble powders or granules, which may contain surface-active agents to improve water dilution and prevent crystallization in a spray tank.

Aqueous suspension concentrates of largely insoluble solids may be prepared by ball or bead milling with a dispersing agent with a suspending agent included to stop the solid settling. Compositions to be used as sprays may be in the form of aerosols wherein the formulation is held in a container under pressure of a propellant, e.g. fluorotrichloromethane or dichlorodifluoromethane. They may also be formulated in biodegradable polymeric formulations to obtain a slow, controlled release of the active substance. Water dispersible powders, emulsifiable concentrates and suspension concentrates will normally contain surfactants, e.g. a wetting agent, dispersing agent, emulsifying agent or suspending agent. These agents can be cationic, anionic or non-ionic agents.

Concentrates should preferably be able to withstand storage for prolonged periods and after such storage be capable of dilution with water in order to form aqueous preparations which remain homogeneous for a sufficient time to enable them to be applied by conventional spray equipment.

It is usually desirable, particularly in the case of foliar spray formulations, to include adjuvants, such as wetting agents, spreading agents, dispersing agents, stickers, adhesives and the like in accordance with agricultural practices. Such adjuvants commonly used in the art can be found in McCutcheon's “Emulsifiers and Detergents”, McCutcheon's “Emulsifiers and Detergents/Functional Materials” and McCutcheon's “Functional Materials” all published annually by McCutcheon Division of MC Publishing Company (New Jersey). The herbicide compositions of the present invention typically have one or more surfactants. The surfactants customarily employed in the art of formulation of mixtures for foliar sprays or soil drenches are described e.g. in “1985 International McCutcheon's Emulsifiers and Detergents” Glen Rock, N.Y. 07452, USA; “Encyclopedia of Surface Active Agents”, Chemical Publishing Co., Inc. New York, 1980. Suitable surface-active compounds are onionic, amphoteric and/or anionic surfactants having good emulsifying, dispersing and wetting properties. The term “surfactants” will also be understood as comprising mixtures of surfactants.

Surfactants improve the uptake, distribution, adhesive power and resistance to rain on treated surfaces. Other additives may be included to improve the biological efficacy such as surface active materials to improve the wetting and retention on surfaces treated with the formulation and the uptake and mobility of the active material. These include oil based spray additives, for example, certain mineral oil and natural plant oil (such as soya bean and rape seed oil) additives, or blends of them with other adjuvants.

The invention is further described by the following non-limiting examples.

### EXAMPLES

### EXAMPLE 1

Composition of Biologic/Nutrient Mixtures

The microorganisms used in the experiments described in Example 2 were provided by Naturize PRIME® and RAPID RESPONSE®.

| Contents: | Concentration: |
|---|---|
| Naturize PRIME ® | |
| Bacillus subtilis A | 28 × 10⁵ cfu/ml |
| Bacillus amyloliquefaciens A | 7.5 × 10⁵ cfu/ml |
| Bacillus amyloliquefaciens B | 9.5 × 10⁵ cfu/ml |

All bacteria in Naturize PRIME ® are in spore form. Naturize PRIME ®
(Spore form) contains a total of 4.5 × 10⁶ cfu/ml.

| | |
|---|---|
| Naturize RAPID RESPONSE ® | |
| Bacillus subtilis B | 2.2 × 10⁸ cfu/ml |
| Bacillus amyloliquefaciens C | 5.9 × 10⁷ cfu/ml |
| Bacillus subtilis | 8.9 × 10⁷ cfu/ml |

All bacteria in Naturize RAPID RESPONSE ® are active in the vegetative
form. Naturize RAPID RESPONSE ® contains a total of 3.68 × 10⁸
cfu/ml ml.

The bacteria in Naturize RAPRID RESPONSE™ and Naturize PRIME™ have some inherent, suppressive activity against pathogenic fungi which is beneficial to the soil.

1 ml RAPID RESPONSE®+1 ml Naturize PRIME® 3.725×108 cfu/per 2 ml or 1.86×108 cfu/ml.

1.86×108 cfu/ml 1:1 RAPID RESPONSE®+Naturize PRIMES×29.57 ml/oz=0.551×1010 cfu/oz. of 1:1 RAPID RESPONSE®+Naturize PRIME®.

0.551 1010 cfu/oz.×16 oz 1:1 RAPID RESPONSE®+Naturize PRIME® in the final product=8.816×1010 cfu/16 oz. 8.816×1010 cfu is the amount of microorganisms that were diluted to a final volume of forty (40) gallons which is appropriate for application to about one acre of crops.

If 8 oz. of PRIME® and PRIMED are added to 40 gallons, the final 40 gallon formulation will contain 0.156 volume % each of Naturize PRIME® and Naturize RAPID RESPONSE®.

All bacteria and microorganisms in the present invention were suspended in an aqueous solution. The nutrient component used in Examples 2 and 3 below is a liquid complex humate-based carbon nutrient-containing matrix nutritive component concentrate called Naturize™ Plus that contains 2.3 volume % humic acid, and 5.1 volume % kelp extract (Ascophylum nodostum) dissolved in aqueous solution.

### EXAMPLE 2

Greenhouse Test: Round-UP® with and without Microbes and Nutrients

Twenty-seven 4-inch pansies in peat media were tested; three controls received just water. Plants were divided into eight groups of three plants each and treated with nine different combinations of water, herbicide, bacteria and humatic nutrients. Each mixture also contained glucopon surfactant (comprising about 9.9 volume % of the final formulation) and harpin protein (comprising about 0.01 volume % of the final formulation). Each plant was sprayed to runoff with the respective formulation listed below:
1. Water only.
2. Full strength ready-to-use Round-UP®. The active ingredient in undiluted ready-to-use Round-UP® is glyphosate (N-phosphonomethylglycine), which comprises about 4% of the ready-to-use product.
3. Full strength ready-to-use Round-UP® was diluted 50%, with a mixture made of equal amounts by volume of Naturize Prime and Naturize Plus. Thus, the active ingredient comprises about 2% of the final solution.
4. Full strength ready-to-use Round-UP® was diluted 50%, with a mixture made of equal amounts by volume of Naturize Rapid Response and Naturize™ Plus. Thus, the active ingredient comprises about 2% of the final solution.
5. Full strength ready-to-use Round-UP® was diluted 50%, with a mixture made of equal amounts by volume of Naturize Rapid Response, Naturize Prime and Naturize™ Plus. Thus, the active ingredient comprises about 2% of the final solution.
6. Full strength ready-to-use Round-UP® was diluted 50%, with an equal amount by volume of Naturize™ Plus (no microbes were added). Thus, the active ingredient comprises about 2% of the final solution.
7. Full strength ready-to-use Round-UP® was diluted 50%, with an equal amount by volume of Naturize Rapid Response (no nutrients were added). Thus, the active ingredient comprises about 2% of the final solution.
8. Full strength ready-to-use Round-UP® was diluted 50%, with an equal amount by volume of Naturize Prime (no nutrients were added). Thus, the active ingredient comprises about 2% of the final solution.

Full strength ready-to-use Round-UP® was diluted 50%, with a mixture made of equal amounts by volume of Naturize Prime and Naturize Plus. Thus, the active ingredient comprises about 2% of the final solution.

Full strength ready-to-use Round-UP® was diluted 50%, with a mixture made of equal amounts by volume of Naturize Rapid Response and Naturize™ Plus. Thus, the active ingredient comprises about 2% of the final solution.

Full strength ready-to-use Round-UP® was diluted 50%, with a mixture made of equal amounts by volume of Naturize Rapid Response, Naturize Prime and Naturize™ Plus. Thus, the active ingredient comprises about 2% of the final solution.

Full strength ready-to-use Round-UP® was diluted 50%, with an equal amount by volume of Naturize™ Plus (no microbes were added). Thus, the active ingredient comprises about 2% of the final solution.

Full strength ready-to-use Round-UP® was diluted 50%, with an equal amount by volume of Naturize Rapid Response (no nutrients were added). Thus, the active ingredient comprises about 2% of the final solution.

Full strength ready-to-use Round-UP® was diluted 50%, with an equal amount by volume of Naturize Prime (no nutrients were added). Thus, the active ingredient comprises about 2% of the final solution.

All plants were sprayed to runoff one time and monitored daily. Seven days after application, the only plants desiccated were those treated with solutions (3) and (5). Controls showed no decline. All other combinations showed decline (measured by a visible loss of turgor, color fade, height reduction, and leaf drop), but not mortality. Thus, adding microbes and nutrients dramatically increased the efficacy of Round-UP® against pansies. In this study of pansies, Naturize™ Prime plus nutrients (3) caused mortality, while Naturize™ Rapid Response (4) did not. A mixture of Rapid Response plus Prime with nutrients (5) was effective in causing mortality. The results show that the addition of microbes and nutrients to herbicide dramatically decreased the amount of herbicide that was needed. Half strength ready to use Round-UP® with microbes and nutrients was effective in desiccating pansies, while full strength Round-UP® alone caused only a decline in vitality but produced no mortality.

### EXAMPLE 3

Field Test Round-UP® with and without Microbes

Twenty-seven 18-inch circles of wild clover, pusley, ragweed and thistle were divided into groups of three and sprayed to runoff with approximately two liquid ounces of:
MIX I=Full strength ready-to-use Round-UP®.
MIX II=Full strength ready-to-use Round-UP® diluted 50%, with a mixture made of equal amounts by volume of Naturize™ Prime and Naturize™ Plus.

After 7 days, the clover mortality was 100% with both mixes. However, full strength ready-to-use Round-UP® was only effective in desiccating clover. The other plants exhibited partial desiccation, and retained significant vigor to regenerate and survive. By contrast, the formulation of the present invention which added microbes and nutrients to ready-to-use Round-UP® diluted by 50%, induced complete mortality in clover and all of the other plants after seven days. Thus, the BCH composition of the present invention in MIX II that used only half the manufacturer recommended strength of ready-to-use Round-UP® was more effective on all plants than full strength ready to use Round-UP®. Importantly, the addition of microbes also broadened the spectrum of weeds that were desiccated. When desiccation is obtained using lower amounts of herbicide as in the present invention, the risk of “drift” of the herbicide onto adjacent plants that are not targeted for killing is dramatically reduced. Moreover, because the cost of the fatty acid herbicide is by far the most significant cost, a herbicide mixture that uses less fatty acid is much more cost effective. The results of this experiment showed that adding microbes to the chemical herbicide decreased the amount of herbicide needed for complete desiccation by at least half.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A herbicide composition comprising:
a. one or more chemical herbicides, and
b. microorganisms selected from the group including bacteria, fungi, microfungi, mold, lichens, algae, viruses, protozoa, and yeast.

2. The composition of claim 1, further comprising nutrients in an amount sufficient to support the growth and replication of the microorganisms in the herbicide composition

3. The herbicide composition as in claim 1, formulated so that the microorganisms are in an amount sufficient to provide from about 1×10⁴ to about 1×10¹⁴ cfu per treated acre.

4. The herbicide composition as in claim 2, wherein the nutrients comprise a complex carbon nutrient-containing matrix.

5. The herbicide composition as in claim 4, wherein the complex carbon nutrient-containing matrix is humate based.

6. The herbicide composition as in claim 1, wherein the microorganisms comprise gram-positive bacteria.

7. The herbicide composition as in claim 1, wherein the microorganisms comprise gram-negative bacteria.

8. The herbicide composition as in claim 1, wherein the microorganisms comprise a mixture of gram-positive and gram-negative bacteria.

9. The herbicide composition as in claim 1, wherein the microorganisms comprise yeast.

10. The herbicide composition as in claim 1, wherein the microorganisms comprise algae.

11. The herbicide composition as in claim 1, wherein the microorganisms comprise bacteria that have suppressive activity against pathogenic fungi.

12. The herbicide composition of claim 6, wherein the gram positive bacteria comprise Bacillus bacteria selected from the group comprising Bacillus subtilis A, Bacillus amyloliquefaciens A, Bacillus amyloliquefaciens B, Bacillus subtilis B, Bacillus amyloliquefaciens C, Bacillus subtilis, Bacillus popalliae, and Bacillus megatherium.

13. The herbicide composition as in claim 1, wherein an amount of a chemical herbicide applied is within a range of from about a maximum label rate, to about 10% of a minimum label rate.

14. The herbicide composition as in claim 1, further comprising an agriculturally effective amount of adhesive, surfactant or dispersant.

15. The herbicide composition as in claim 4, wherein the complex carbon nutrient-containing matrix comprises kelp or kelp extracts.

16. The herbicide composition as in claim 1, further comprising a member selected from the group comprising plant hormones, auxins, cytokinins, betains, plant growth factors, vitamins, beneficial enzymes, and harpin protein.

17. The herbicide composition as in claim 1, wherein the chemical herbicide is a fatty acid herbicide.

18. The herbicide composition as in claim 1, wherein the fatty acid herbicide is N-phosphonomethylglycine.

19. The herbicide composition as in claim 1, wherein the chemical herbicide is a bypridilium compound.

20. The herbicide composition as in claim 1, wherein the microorganisms are in a vegetative state.

21. The herbicide composition as in claim 1, wherein the microorganisms are in spore form.

22. A method of controlling or preventing weeds, comprising applying to the weeds or to the locus of the weeds, an herbicidally effective amount of the herbicide composition of claim 1.

23. The herbicide composition as in claim 1, wherein the microorganisms comprise a mixture of bacteria comprising Bacillus subtilis B, Bacillus amyloliquefaciens C, and Bacillus subtilis.

24. The herbicide composition as in claim 1, wherein the microorganisms comprise a mixture of bacteria, comprising Bacillus subtilis A, Bacillus amyloliquefaciens A, and Bacillus amyloliquefaciens B.
